(19) United States
(12) Patent Application Publication
(10) Pub. No.: US 2025/0291798 A1
(43) Pub. Date: Sep. 18, 2025

(54) IO SCHEDULING METHOD AND DEVICE OPERATING THE SAME

(71) Applicant: Samsung Electronics Co., Ltd., Suwon-si (KR)

(72) Inventor: Soo Young Ji, Suwon-si (KR)

(73) Assignee: Samsung Electronics Co., Ltd., Suwon-si (KR)

(21) Appl. No.: 18/966,776

(22) Filed: Dec. 3, 2024

(30) Foreign Application Priority Data
Mar. 15, 2024 (KR) 10-2024-0036605

(51) Int. Cl. G06F 16/2455; G06F 9/48; G06F 16/22

(52) U.S. Cl. CPC G06F 16/24552; G06F 9/4881; G06F 16/2282

(57) ABSTRACT

IO scheduling method and device operating the same, are provided. A device connected to a host device through a CXL protocol, the device comprises a device memory which stores a query plan table and query plan status information synchronized with the host device and a device processor which processes a task according to the query plan table and updates query plan status information when receiving an operation command from the host.

### CROSS-REFERENCE TO RELATED APPLICATION

This application claims priority and the benefit under 35 U.S.C. § 119(a)-(d) of Korean Patent Application No. 10-2024-0036605, filed on Mar. 15, 2024, in the Korean Intellectual Property Office, the contents of which in its entirety are herein incorporated by reference.

### FIELD

The present invention relates to an I/O scheduling method in a device that processes a query.

### BACKGROUND

A host device may provide commands (e.g., read and write commands) for processing to a plurality of devices. The host device may perform a database scan operation. The host device requests or manipulates information in the database by the use of query. For example, the host device inputs and outputs data to read and write data that satisfies query criterion in the database.

However, when it takes a long time to load or process data requested by one of the plurality of devices, there is difficulty in that task execution in proceeding to the next stage is delayed, and overall command execution therfore is delayed.

### SUMMARY

Aspects of the present invention provide an I/O scheduling method and a device thereof in which an operation performance is improved.

According to an aspect of the present disclosure, there is provided a device connected to a host device through a CXL protocol, the device comprising a device memory which stores a query plan table and query plan status information synchronized with the host device and a device processor which processes a task according to the query plan table and updates query plan status information when receiving an operation command from the host.

According to an aspect of the present disclosure, there is provided a host device connected to a plurality of devices through a CXL protocol, the host device comprising a host memory which stores query plan status information synchronized with the plurality of devices and a host processor which transmits to any one of the plurality of devices on the basis of the query plan status information an operation command.

According to another aspect of the present disclosure, there is provided an I/O scheduling method between a host device and a plurality of devices, the I/O scheduling method comprising checking by the host device query plan status information about the plurality of devices,, transmitting to any one of the plurality of devices on the basis of the query plan status information, by the host device an operation command, updating by a device that has received the operation command a task corresponding to the operation command to a query plan stored in advance, performing by the device that has received the operation command a task according to the updated query plan, and replying the updated content of the query plan status information to the host device,.

However, aspects of the present invention are not restricted to the one set forth herein. The above and other aspects of the present invention will become more apparent to one of ordinary skill in the art to which the present invention pertains by referencing the detailed description of the present invention given below.

The I/O scheduling method and device of the present invention may reduce frequent I/O commands and dramatically reduce a bottleneck phenomenon of I/O channels.

The I/O scheduling method and device of the present invention may secure resources of a host device and efficiently manage each device.

### BRIEF DESCRIPTION OF THE DRAWINGS

The above and other aspects and features of the present disclosure will become more apparent by describing in detail exemplary embodiments thereof with reference to the attached drawings, in which:

FIGS. 1 and 2 are conceptual diagrams for explaining the bottleneck phenomenon of the I/O interface.

FIGS. 3 and 4 are block diagrams for explaining an I/O scheduling system according to some embodiments.

FIG. 5 is a block diagram for explaining an I/O scheduling operation according to some embodiments.

FIG. 6 is a table for explaining query plan status information according to some embodiments.

FIG. 7 is a table for explaining a query plan table for each device according to some embodiments.

FIG. 8 is a flowchart for explaining an I/O scheduling method according to some embodiments.

### DETAILED DESCRIPTION

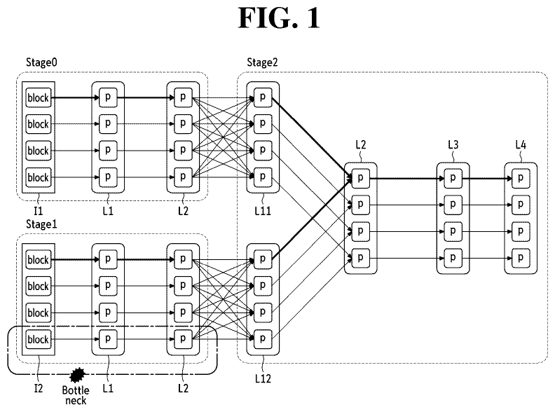

Hereinafter, an I/O scheduling method and a device thereof according to some embodiments of the present invention will be described with reference to FIGS. 1 to 8.

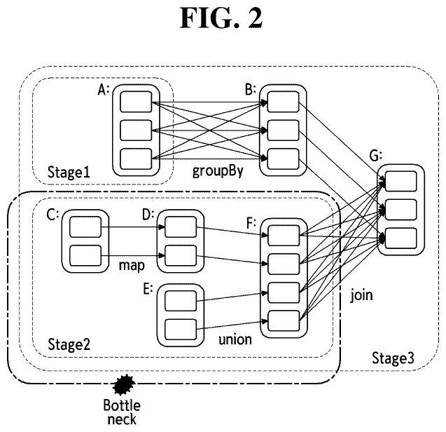

FIGS. 1 and 2 are conceptual diagrams for explaining the bottleneck phenomenon of the I/O interface. A single query is executed via multiple stages, with each stage processing at least one task. Each stage is achieved by dividing the entire task for executing the query for each of arbitrary functions and purposes.

Referring to FIG. 1, a host may read data from a variety of storage devices in a desired format. For example, assuming that data p is read from a plurality of blocks included in a storage device of Stage 0, and data p is read from a plurality of blocks included in a storage device of Stage 1. This example also assumes that data p read each in Stage 0 and Stage 1 are received in Stage 2, with the received data p being subjected to processing such as adding-up, filtering or selecting to generate data r, and data r is stored.

Assuming that a first time for reading the data p stored in any block of Stage 1 is much slower than a second time for reading the data p of Stage 0, and a third time for reading the data p stored in the remaining blocks of Stage 1. In this case, the time required to generate data r in Stage 2 is determined on the basis of the first time. That is, when the data loading in a specific block is significantly slower than in other blocks, it may be considered that a bottleneck phenomenon for data I/O has occurred due to the specific block.

Referring to FIG. 2, for example, in Stage 1, task A is grouped into task B (Group). In Stage 2, data about task C is mapped to data about task D, and data about task F is generated by uniting task D and task E. In Stage 3, the data about task G is generated by joining the data about task F and the data about task B. That is, in order to obtain data of Stage 3, data of Stage 1 and Stage 2 should be provided at a same or near time. However, since Stage 2 has more tasks compared to Stage 1, there may be required more processing to get tasks C, D, E, and F, and the consequent data loading may be further delayed. The data processing of task G may be delayed depending on the processing in Stage 2. That is, Stage 2 may cause a bottleneck phenomenon.

In the bottleneck phenomenon, as shown in FIGS. 1 and 2 due to command I/O, a situation in which the CXL interconnect becomes busy increases, as the number of devices 200 connected to the host device 100 increases and/or as the complexity of the stage increases. For example, if there are 64 devices 200 connected to the host device 100, for example, there are 64 storage devices, 64 I/O commands are generated for each stage for the 64 storage devices. If each of two I/O commands, including transmit and reply, occur in one stage for each of the 64 storage devices, a total of 128 (=64×2) I/O commands may occur. Furthermore, if the number of stages is assumed to be 100, a minimum of 12,800 (=128×100) I/O commands is generated overall.

The 12,800 I/O commands are stacked in a command queue and may then be transmitted in any prescribed way, such as FIFO way (First In First Out). However, if the processing time at a specific stage increases, processing speed in another stage may also be delayed. To alleviate such a bottleneck phenomenon, there is a need to make more efficient I/O scheduling between hosts and devices.

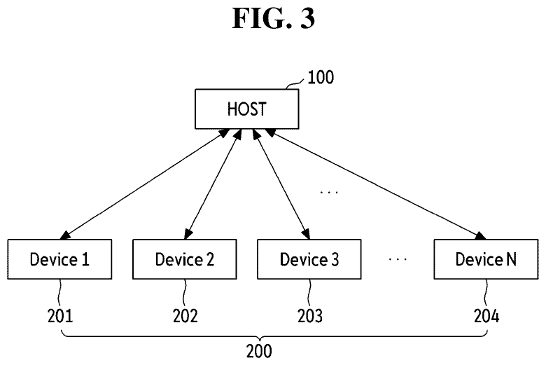

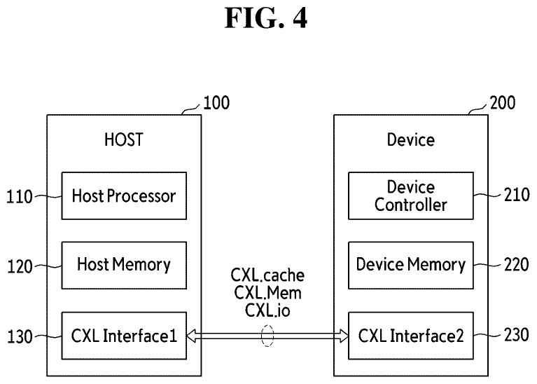

FIGS. 3 and 4 are block diagrams illustrating an I/O scheduling system according to some embodiments.

Referring to FIGS. 3 and 4, the I/O scheduling system may include a host device 100 and a plurality of devices (Device 1 to Device N, 201 to 204; 200). The plurality of devices 200 may be connected to the host device 100 through a CXL (Compute Express Link) interface. The device 200 may be, for example, a storage device such as a database.

The host device 100 may include a host processor 110, a host memory 120, and a host interface 130. The host processor 110 may be, for example, a general-purpose processor, such as a central processing unit (CPU) core of the host device 100. The host memory 120 may include, for example, random access memory (RAM) (e.g., a dynamic random access memory (DRAM)), a read-only memory (ROM), and the like. The host interface 130 may communicate with the device 200.

The host memory 120 may store query plan status information. The query plan status information may include for each query a task progress status, a current progress stage, a progress status for each device, a delay time, and the like.

The device 200 may include a device controller 210, a device memory 220, and a device interface 230. The device controller 210 may be a processor, such as a regional processing unit core. The device memory 220 may include, for example, a random access memory (RAM) (e.g., a dynamic random access memory (DRAM)), a read-only memory (ROM), and the like. The device interface 230 is capable of communicating with the host device 100.

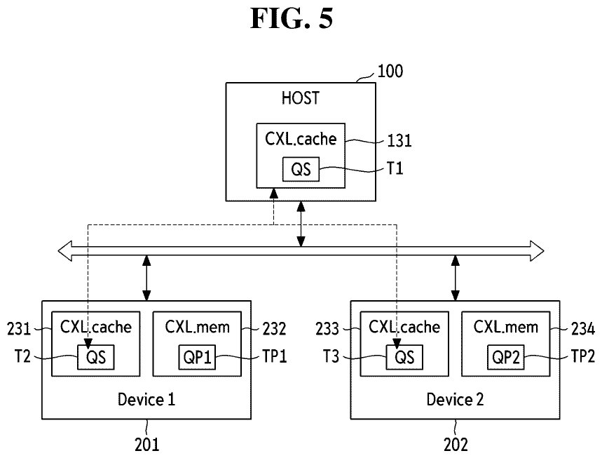

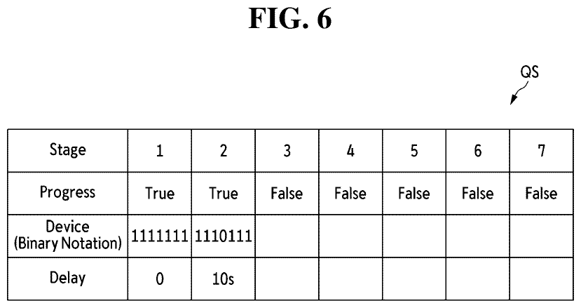

The device memory 220 may store query plan status information (QS). The query plan status information is illustrated in more detail in FIG. 5. The device memory 220 may further include a query plan table. The query plan table will be explained in more detail with reference to FIG. 6.

Communication may be performed, using a wired and/or wireless communication medium, interface, network, interconnect, protocol, etc. These may include coherent protocol such as PCIe (Peripheral Component Interconnect Express), NVMe (Nonvolatile Memory Express), NVMe-oF (NVMe over Fabric), CXL (Compute Express Link), and/or CXL.mem, CXL.cache, and CXL.IO, Gen-Z, OpenCAPI (Open Coherent Accelerator Processor Interface), CCIX (Cache Coherent Interconnect for Accelerators), AXI (Advanced extensible Interface), DMA (Direct Memory Access), RDMA (Remote DMA), ROCE (RDMA over Converged Ethernet), AMQP (Advanced Message Queuing Protocol), Ethernet, TCP/IP (Transmission Control Protocol/Internet Protocol), FibreChannel, InfiniBand, SATA (Serial ATA), SCSI (Small Computer Systems Interface), SAS (Serial Attached SCSI), iWARP, any generation of wireless networks including 2G, 3G, 4G, 5G, and 6G, any generation of WiFi, Bluetooth, NFC (near-field communications) or any combination thereof.

Although the host interface 130 and the device interface 230 are not limited to any particular implementation details, they may be implemented with a CXL interconnect for purposes of explaining principles of the disclosure. The CXL interconnect is an open industry standard interconnect, and provides high bandwidth and low latency connections between the host processors 110 and the device 200 such as a smart I/O device, an accelerator, and a memory buffer. The CXL interconnect enables cache coherency and memory semantics for multidimensional processing and memory systems for optimized performance in evolving usage models. Additionally, the CXL interconnect may support cache line segmentation, that is, 64-byte memory accesses, and may support switching that allows fan-out to many devices, which may be useful for a memory expansion. The host interface 130 may be connected to the device 200, for example, through CXL.mem protocol, CXL.cache protocol, and CXL.io protocol.

The CXL.cache protocol is a link that allows the device 200 to access the host memory 120, and the CXL.mem protocol is a link that allows the host 100 to access the device memory 100. The CXL.io protocol is based on a PCIe (Peripheral Component Interconnect Express) specification, and a link related to a device search, a configuration, a register access, a suspension, etc.

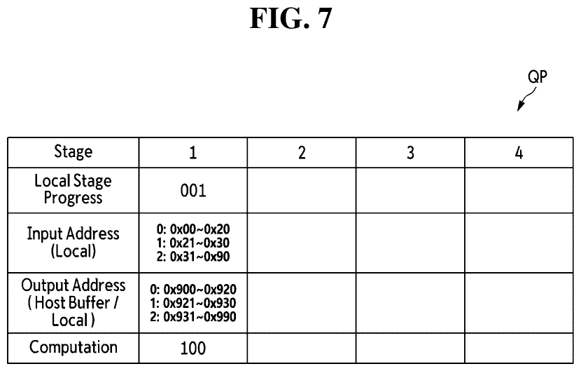

FIG. 5 is a block diagram illustrating an I/O scheduling operation according to some embodiments, and FIG. 6 is a table illustrating query plan status information according to some embodiments. FIG. 7 is a table illustrating a query plan table for each device according to some embodiments.

Referring to FIG. 5, the host device 100 transmits a query for requesting the information or manipulating to the device 200. In order to transmit the query, the host device 100 may control query transmission for each stage and device by referring to the query plan status information QS. For example, when the task processing of at least one device X among the plurality of devices 200 is delayed in stage K among M stages (M is a natural number of two or more), the host device 100 may perform other tasks that may be combined by referring to the query plan state information (QS). The other tasks that may be combined may be tasks that belong to the same stage K, or may be tasks that belong to another stage L that may be processed in parallel with stage K.

The host device 100 stores host memory 110 the query plan status information in the. The device 200 may store the query plan status information QS, which is stored in the device memory 220, synchronously in the host memory 110 through the CXL.cache protocol.

The device 200 may store in the device memory 220a query plan QP. The query plan QP is managed independently for each device. That is, a query plan QP1 of a first device (Device 1) is different from a query plan QP2 of a second device (Device 2). In other words, since the query plan is managed in the device 200, it may not be mixed with progress information about queries of other devices, and is not stored in the host device 100, which allows the resources of the host memory 120 to be written more efficiently.

The host device 100 may learn an expected time required for task (or a waiting time) for each device through the synchronized query plan status information, and may perform other tasks on the basis of the expected waiting time.

According to some embodiments, the device processor 210 updates the query plan status information of the device memory 220 after performing the task, and then transmits to the host device 100 the updated query plan status information. The device 200 may transmit to the host device 100 the query plan status information each time it is updated, or may transmit to the host device 100 the query plan status information periodically, or may transmit to the host device 100 the query plan status information at the request of host device 100 in accordance with some embodiments.

Referring to FIG. 6, the query plan status information QS synchronized between the host device 100 and the device 200 includes factors that affect the query execution speed between the host device 100 and the device 200. For example, the query plan status information QS may include per query a task progress status (indicated by Stage), a current progress stage (indicated by Progress), a progress status for each device (indicated by Device), a delay time (indicated by Delay) and the like.

The task progress status is displayed for each of multiple stages (for example, 1 to 7), and the current progress stage is indicated by True when all tasks of that stage have been completed or are being processed, and the current progress stage is indicated by False, before the first task processing starts in that stage. The progress status for each device is expressed in binary notation for each device, including an indication of 1 in the case of the processing completion, and an indication of 0 before the processing completion. The delay time indicates the remaining time until the task of the stage is completed, on the basis of the expected processing waiting time of each task belonging to the stage.

FIG. 6 illustrates a case where seven devices 200 are connected to the host device 100. The progress status of the device 200 may be expressed in binary notation, such as by 0000000 to 1111111. For example, when that stage is completed, it may be indicated by 1, and before the processing or in an uncompleted state, it may be indicated by 0.

During the task progress stage, in the query plan status information QS of Stage 1, the progress status for each device may be indicated by 111111 when the progress in all devices is completed, the current progress stage (Progress) may be indicated by True, and the delay time may be indicated by 0.

During the task progress stage, since the query plan status information QS of Stage 2 (Stage 2) is currently in progress, the current progress stage (Process) is indicated by True, when the progress in any device is not completed, for example, when the task of the fourth device is not completed, it may be indicated by 1110111, and the waiting time until the task of the fourth device is completed and all tasks of Stage 2 are completed may be indicated by 10 seconds (10 s).

Since stages 3 to 7 after Stage 2 occurs before the task processing start, the current progress status (Progress) is indicated by False. The progress status for each device and delay time may be set to Null.

As described above, since the host device 100 stores the synchronized query plan status information QS in the host memory 120, it is possible to know the stage progress status and the processing state for each device 200. The host device 100 may control the device 200 to execute other tasks that may be processed in parallel or preprocessed, in consideration of the delay time 10 seconds of the fourth device in the example shown in FIG. 6.

Referring to FIGS. 5 and 7, each device 201 stores the query plan table QP of that device. The device processor 210 processes the task according to the query plan table QP stored in the device memory 220, and updates the query plan status information QS after processing the task. Accordingly, the host device 100 may manage the query plans QP1 and QP2 for each device through the query plan status information QS.

The query plan table QP may include, for example, a stage, a local stage process, an input address, an output address, and a computation level. The Stage is a stage level for a query, and may be reference information for synchronizing with the query plan status information QS. The local stage process indicates an internal stage progression stage for each device 200 among all stages, the input address indicates the address of the device memory 220 to read with the query request, and the output address indicates the address of the host memory 120 to output the data that is read from the device memory 220. The computation level indicates a stage in which the computation is performed.

By way of example, in Stage 1, when the internal stage processing of the first device 201 is three stages in total and one stage is currently in progress, the first device 201 indicates the local stage processing as “001”. The input address and the output address may be determined as an address range of 0 in the first stage, an address range of 1 in the second stage, and an address range of 2 in the third stage, among a total of three stages.

The input address indicates the address in the device memory 220 to be read on the basis of the progress stage of the local stage process. For example, since the current local stage process is in the first stage 1, the input address is in the address range of 0 (0x00 to 0x20), and the device processor 210 may read the data requested for query in 0x00 to 0x20 of the device memory 220.

The output address indicates the address of the host memory 120 to be output on the basis of the progress stage of the local stage process. For example, since the current local stage process is in the first stage, the output address is in the address range of 0 (0x900 to 0x920), and the device processor 210 outputs the data that is read through the CXL.mem protocol in the address range of 0 of the host memory 120.

The computation level may be indicated as “100” to execute the accelerator third in a total of three stage local processes. For example, the delay time of query plan status information may be calculated on the basis of the computation level.

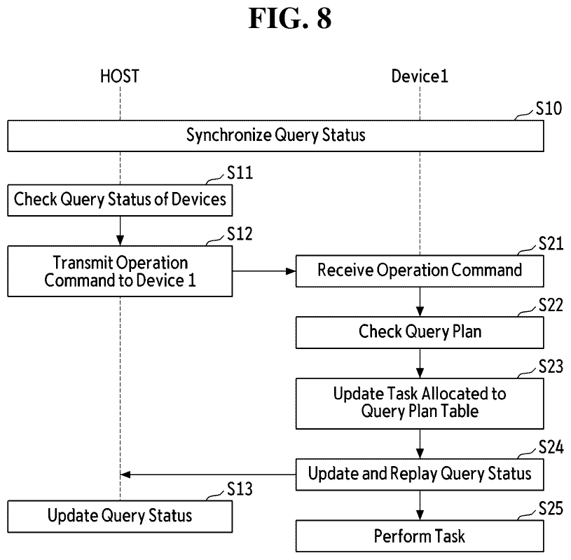

FIG. 8 is a flowchart illustrating an I/O scheduling method according to some embodiments. For convenience of explanation, although the I/O scheduling method between the host device 100 and the first device 201 will be described below, the method is applicable to all the devices described in FIG. 3.

The host device 100 and the first device 201 synchronize the query plan status information QS through the CXL.cache protocol (S10). Step S10 may be after the system start-up of the host device 100 and the first device 201, or may be after step S13.

The host device 100 checks the query plan status information of each device 200 (S11). The host device 100 transmits an operation command to the first device 210 capable of parallel processing during the delay time on the basis of the query plan status information QS (S12). When the first device 201 receives the operation command (S21), it checks the query plan QP1 of the first device (S22), and updates the task corresponding to the operation command in the query plan table (S23). The first device 201 updates the query plan status information QS on the basis of the updated query plan table QP1, and replies the updated content to the host device 100 (S24). The first device 200 executes the allocated task on the basis of the query plan table QP1 (S25), and the host device 100 updates by reflecting the replied update content to the stored query plan status information (S13).

As in the shown examples, since the device 200 operates on the basis of the query plan table QP, it may predict the use of query processing and prepare for task processing, and the host device 100 may control the number of I/O commands of the network interface with the devices, while efficiently processing the query only by the query plan status information QS. Accordingly, it is possible to conserve the resources of host memory and reduce the network complexity with the device.

Although the embodiments of the present invention have been described above with reference to the accompanying drawings, the present invention is not limited to the above embodiments, and may be fabricated in various different forms. Those skilled in the art will appreciate that the present invention may be embodied in other specific forms without changing the technical spirit or essential features of the present invention. Accordingly, the above-described embodiments should be understood in all respects as illustrative and not restrictive.

What is claimed is:

1. A device connected to a host device through a CXL protocol, the device comprising:
a device memory which stores a query plan table and query plan status information synchronized with the host device; and
a device processor which processes a task according to the query plan table and updates the query plan status information when receiving an operation command from the host.

2. The device of claim 1,
wherein the updated query plan status information is transmitted to the host device through a CXL.cache protocol.

3. The device of claim 1,
wherein the query plan table is stored and updated in the device memory according to a CXL.mem protocol.

4. The device of claim 1,
wherein the query plan status information includes a task progress status, a current progress stage, a progress stage for each device, and a delay time.

5. The device of claim 1,
wherein the query plan table includes a stage for each query of the device, a local stage process, an input address for the device memory, an output address for a host memory, and a computation level.

6. The device of claim 5,
wherein the local stage process indicates a progress stage of an internal stage of the device in the stage for each query.

7. The device of claim 6,
wherein the input address and the output address are determined on the basis of the progress stage of the local stage process.

8. A host device connected to a plurality of devices through a CXL protocol, the host device comprising:
a host memory which stores query plan status information synchronized with the plurality of devices; and
a host processor which transmits to any one of the plurality of devices on the basis of the query plan status information an operation command.

9. The host device of claim 8,
wherein the query plan status information includes a task progress status of a query request of the host device for each device, a current progress stage, a progress status for the device, and a delay time.

10. The host device of claim 8,
wherein the device that received the operation command updates a task corresponding to the operation command to the query plan table, and
performs an allocated task on the basis of the query plan table.

11. The host device of claim 10,
wherein the query plan table includes a stage for each query of the device, a local stage process, an input address for the device memory, an output address for a host memory, and a computation level.

12. The host device of claim 10,
wherein the host device receives an update content from the device on the updated query plan table.

13. The host device of claim 12,
wherein the query plan status information is received through a CXL.cache protocol.

14. The host device of claim 11,
wherein the device accesses an output address of the host memory determined on the basis of the progress stage of the local stage process.

15. An I/O scheduling method between a host device and a plurality of devices, the I/O scheduling method comprising:
checking by the host device query plan status information about the plurality of devices,;
transmitting by the host device an operation command to any one of the plurality of devices on the basis of the query plan status information;
updating by a device that has received the operation command a task corresponding to the operation command to a query plan stored in advance; and
performing by the device that has received the operation command a task according to the updated query plan, and replying to the host device the updated content of the query plan status information,.

16. The I/O scheduling method of claim 15,
wherein the query plan status information of the host device is updated and synchronized with the plurality of devices through a CXL.cache protocol.

17. The I/O scheduling method of claim 15,
wherein the query plan status information includes a task progress status of a query request of the host device for the device, a current progress stage, a progress status for each device, and a delay time.

18. The I/O scheduling method of claim 17,
wherein the host device selects any one of the plurality of devices and transmits the operation command to process a stage or a task that may be combined among the plurality of stages, on the basis of the delay time.

19. The I/O scheduling method of claim 15,
wherein the query plan table is stored in a device memory belonging to each of the plurality of devices according to a CXL.mem protocol.

20. The I/O scheduling method of claim 19,
wherein the query plan table includes a stage for each query, a local stage process, an input address for the device memory, an output address for a host memory, and a computation level.
